(19) United States
(12) Patent Application Publication
(10) Pub. No.: US 2012/0021151 A1
(43) Pub. Date: Jan. 26, 2012

(54) Transparent, Flexible Products Made With Partially Crystalline Cycloolefin Elastomer

(76) Inventors: Paul D. Tatarka, Union, KY (US); Timothy M. Kneale, Florence, KY (US); Barbara Canale-Schmidt, Readsboro, VT (US)

(21) Appl. No.: 13/248,272

(22) Filed: Sep. 29, 2011

Related U.S. Application Data
(63) Continuation-in-part of application No. 13/199,624, filed on Sep. 2, 2011.
Application No. 13/199,624 is a continuation-in-part of application No. 13/066,118, filed on Apr. 7, 2011.
(60) Provisional application No. 61/404,278, filed on Sep. 30, 2010.
(60) Provisional application No. 61/403,095, filed on Sep. 10, 2010.
(60) Provisional application No. 61/342,527, filed on Apr. 15, 2010.

(51) Int. Cl. C08F 32/08; B65B 53/00; B32B 1/08; B65D 85/00

(52) U.S. Cl. 428/35.1; 526/281; 206/524.1; 428/36.8

(57) ABSTRACT

Shaped articles made with a partially crystalline, cycloolefin elastomer of norbornene and ethylene typically having at least one glass transition temperature (Tg) in the range of from −10° C. to 15° C. and a crystalline melting temperature in the range of from 60° C. to 125° C. and a % crystallinity by weight in the range of from 5% to 40%. The shaped articles may be in the form of medical tubing; a contact lens mold or component thereof; a container such as a bottle, a squeeze bottle or a squeeze tube; an eyedropper or eyedropper component; an elastomeric closure, optionally a pierceable elastomeric closure or the shaped article is selected from shrink film and/or shrink tubing.

### CROSS-REFERENCE TO RELATED APPLICATIONS

This application is based on U.S. Provisional Patent Application Ser. No. 61/404,278 of the same title, filed Sep. 30, 2010. This application is also a continuation in part of United States patent application Serial No. 13/199,624 filed Sep. 2, 2011, entitled PARTIALLY CRYSTALLINE CYCLOOLEFIN ELASTOMER MEDICAL TUBING which was based upon U.S. Provisional Patent Application Ser. No. 61/403,095, filed Sep. 10, 2010 of like title. This application is also a continuation in part of United States patent application Ser. No. 13/066,118, filed Apr. 7, 2011 entitled MELT BLENDS OF AMORPHOUS CYCLOOLEFIN POLYMERS AND PARTIALLY CRYSTALLINE CYCLOOLEFIN ELASTOMERS WITH IMPROVED TOUGHNESS, which was based on U.S. Provisional Patent Application Ser. No. 61/342,527, filed Apr. 15, 2010. The priorities of the foregoing applications are hereby claimed and the disclosures thereof incorporated into this application in their entireties.

### TECHNICAL FIELD

The present invention is directed, in part, to transparent, flexible products made with partially crystalline norbornene/ethylene elastomer resins which provides an improved property profile; especially all-olefin construction. Norbornene is also sometimes referred to as bicyclo[2.2.1]hept-2-ene or 2-norbornene:

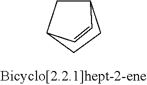

Preferred products include medical tubing, squeeze bottles, squeeze tubes, contact lens molds, eyedroppers, transparent bags, film and other products where transparency, chemical stability, flexibility and elastic elongation and/or high levels of impact resistance are required. Partially crystalline norbornene/ethylene elastomer resins are especially suited for a wide variety of products as described herein. In accordance with the invention, there are provided drug delivery devices with flexible film pouches used as deflatable reservoirs/bladders, in which products the flexible films are made with partially crystalline norbornene/ethylene elastomer resins. An especially useful film for use in bladder type devices, including insulin pumps, is an 80/20 w/w blend of TOPAS® 8007S-04/E-140. Likewise, miniature infusion devices utilize the elastomer and blends of partially crystalline norbornene/ethylene elastomer resins with amorphous cycloolefin containing polymers. The elastomer material may be used for making respiratory drug delivery products, such as CPAP (Continuous Positive Airway Pressure) masks made with E-140 and E-140/COC blends and BiPAP (Bilevel Positive Airway Pressure) masks for sleep apnea with tubing, connectors and filters; respiratory management for various afflictions such as pulmonary disease and jaundice, and ventilatory support systems, ventilation management, and noninvasive monitors, sensor products, dispensing systems, and portable diagnostic analyzers. The material is especially suitable for intravenous (I.V.) sets, catheters for short term tissue contact, such as I.V. catheters, and inhalers due to low adsorption, as well as flexible molds, such as contact lens molds or food molds, such as candy molds to replace silicone, or any process, such as potting, where materials have to set-up in a pure container. Preferred products also include those where low leachables/extractables for purity and/or no off-taste are required. Such products include, for example, hobby bottles and water bottles, dip tubes for aerosols, pumps and cap sets that do not adsorb the product contents so the product is not lost in the tube and the container can be fully emptied without residual product remaining in the vessel. Suitably, the materials are applied in connection with drug delivery via passive transdermal patches for drugs and variations, drug coated adhesive patches that absorb through the skin as well as in connection with biopharmaceuticals that are large-molecule, heavy medicines that do not pass through transdermal patches. The COC elastomers are used in microneedle patches, medical grade foam tape for microneedle arrays, and needle transdermal patches. Microneedle patches for pharmaceuticals with higher molecular weights are used with drugs such as proteins, peptides, macromolecules, and vaccines that can not be delivered by tablets.

### BACKGROUND

In the medical field, where various liquid and dry agents are collected, processed and stored in containers, transported and ultimately delivered through tubes by infusion to patients, there has been a recent trend toward developing materials useful for fabricating such containers and tubing without the disadvantages of currently used materials such as polyvinyl chloride (PVC) or polymers containing BPA, or displaying estrogenic activity (EA). COC-E (sometimes referred to as TOPAS®-E) resin does not have components that affect estrogenic activity, like other polymers and has low surface adsorption. These new medical tubing and container materials must have a unique combination of properties, so that the device can be used in fluid administration sets and with medical infusion pumps. These materials must have good bonding properties, sufficient yield strength and flexibility, be environmentally friendly and compatible with medical solutions. The products of this invention with COC-E can replace (PVC), PVC/olefin co-extrusions, extrudable polyurethanes, polycarbonate urethane, and polyether urethane (TPU), TPE, TPV, thermoplastic rubbers, and silicone as will be appreciated from the discussion hereinafter. Thermoplastic vulcanisates (TPV) are cross linked rubber domains dispersed in polyolefin matrix phase. Commercial examples include Sanoprene™ and Sarlink™ products which are cross linked EPDM finely dispersed in polypropylene matrix phase. COC-E has higher purity and less extractables than TPVs.

It is a requirement that medical products generally be environmentally compatible as a great deal of medical waste is disposed of in landfills and through incineration. For material disposed of in landfills, it is desirable to use as little material as possible. To this end, it is desirable to use a material which is thermoplastically recyclable so that scrap generated during manufacturing may be refabricated into other useful articles.

Optical transparency and/or flexibility are often required in medical as well as consumer products and in connection with advanced manufacturing techniques. For example, a contact lens mold must have transparency for use in connection with some processes so that curative radiation is effective and must have sufficient elongation for use in connection with other processes so that the mold can be stretched to remove a finished lens from the mold.

In medical packaging and consumer products, it is often desirable that the products be visible through a container or other packaging. Some products such as squeeze tubes and eyedropper caps require a high degree of flexibility, while others such as squeeze bottles require less flexibility, but still must have very high impact resistance and relatively good transparency. Chemical purity and stability are also considerations, not only in medical products, but also in feeding products such as baby bottles and water bottles where alternatives to bisphenol A (“BPA”) containing materials such as polycarbonate and/or polymers with estrogenic activity (EA) are sought.

Despite advances in the art, existing systems fail to provide a superior set of attributes, especially with respect to halogen-free and BPA-free, all-olefin containing products and apparatus components.

### SUMMARY OF INVENTION

The present invention provides halogen-free articles with all-olefin construction which is readily recycled and has outstanding chemical stability. The products are made with a partially crystalline elastomer of norbornene and ethylene which has a crystalline melting temperature in the range of from 60° C. to 125° C. and a % crystallinity by weight in the range of from 2.5% to 40%, more preferably from 5 to 40% by weight. The partially crystalline cycloolefin elastomer has at least one glass transition temperature (Tg) of less than 30° C., typically in the range of from −10° C. to 15° C. Optionally, it may also have multiple glass transitions; for example, one occurring at less than −90° C. and another which occurs in the range from −10° C. to 15° C. as described hereinafter.

Chemical purity and surface properties make the products of the invention especially suitable, for example, for use in I.V. sets with flexible tubing and bags or other containers that can be used for infusion therapy to deliver drugs or route fluids such as body fluids via an I.V. port with or without electric pumps that control the I.V. flow. So also, the products include I.V. set accessories including pumps, such as peristaltic and vacuum pumps, or other items such as gas and drain lines, incubators, desiccators, condensers, and analytical instruments as well as components thereof. The low leachables/extractables of the TOPAS-E (COC-E) products as well as their flexibility make them especially preferred for single-use bioprocessing tubing, film bulk bags, bag liners, and injection molded or sheet fabricated accessories—these applications need the low adsorption properties of TOPAS-E much like I.V. sets. So also, the fabricated products of the invention include bulk containers for active pharmaceutical ingredients (API) and containers for food manufacturing and transport-providing large size containers with flexibility. Only small to moderate size containers are possible with TOPAS COC, for example because the material lacks sufficient flexibility. Feeding products likewise require low leachables and extractables. The invention products accordingly include baby bottles, breast pump components, sippy cups, pacifiers, teething rings and water and food containers. Still yet another class of products of the invention where chemical purity and low leachables/extractables are important include products with thermal bonding using TOPAS-E, for example in medical devices since the material enables bonding with flexibility to fabrics and non wovens, not possible with amorpous standard grades of TOPAS COC. All of the these applications require the low leachables/extractables of TOPAS-E much like I.V. sets and accessories.

Adsorption is a significant issue for I.V. sets as well as other products. To ameliorate the adsorption issue olefins or olefin blends such as PE or PP are used for drug contact in a co-extrusion with PVC with drugs such as insulin and nitroglycerin. However, in a PVC/PE co-extrusion the mechanical properties of the tubing such as kink resistance are significantly reduced so professional staff have to take great care handling I.V. lines. Other mechanisms that can be affected include pumps, such as diastolic pumps. The volume may not be reproducible after just a few pump cycles, whereby volume may not be accurately dispensed. The inventive, COC-E containing tubing is suitable for dispensing applications. A particularly desirable feature is that COC-E monolayer tubing has reduced protein adsorption compared to other substrates and improved mechanicals over PVC/olefin co-extrusions, such as PVC/PE as well as better dimensional stability to control ID and OD tolerences in tubing.

Lower adsorption preserves drug potency and significantly reduces drug loss on tubing walls offering a cost effective alternative over multi-layer tubing such as PVC/PE multi-layer and other constructions.

Still further features and advantages will become apparent from the discussion which follows.

### BRIEF DESCRIPTION OF DRAWINGS

The invention is described in detail below with reference to the drawings wherein:

FIG. 1 is a plot of Storage Modulus, E′ and Loss Modulus, E″, vs. temperature for norbornene/ethylene elastomer;

FIG. 2 is a plot of stress versus strain for partially crystalline cycloolefin elastomer, at temperatures of from 50° C. to −50° C.;

FIG. 3 is a plot of storage modulus versus temperature for cross-linked partially crystalline cycloolefin elastomer treated at various energies and dosages;

FIG. 4 is a plot of glass transition temperature (Tg) vs. norbornene content for amorphous COC resins;

FIG. 5 is a diagram in section of a multi-layer, single lumen cylindrical tube of the invention;

FIG. 6 is a diagram, in section, of a dual lumen cylindrical tube of the invention;

FIG. 7 is a diagram, in section, of a four lumen cylindrical tube of the invention; and

FIG. 8 is a diagram of another four lumen tube of the present invention.

### DETAILED DESCRIPTION

The invention is described below with reference to numerous embodiments. Such discussion is for purposes of illustration only. Modifications to particular examples within the spirit and scope of the present invention, set forth in the appended claims, will be readily apparent to one of skill in the art. Terminology used herein is given its ordinary meaning consistent with the exemplary definitions set forth immediately below; % means weight percent or mol % as indicated, or in the absence of an indication, refers to weight percent. Mils refers to thousandths of an inch and so forth.

“Consisting essentially of” and like terminology refers to the recited components and excludes other ingredients which would substantially change the basic and novel characteristics of the composition or article. Unless otherwise indicated or readily apparent, a composition or article consists essentially of the recited components when the composition or article includes 90% or more by weight of the recited components. That is, the terminology excludes more than 10% unrecited components. Similarly, “substantially without” a certain ingredient indicates that a composition has less than 10% of that ingredient in the absence of more specific description of a composition. Preferably, “substantially without” indicates less than 5%, by weight, of the indicated ingredient and still more preferably less than 2.5 weight %.

“Amorphous cycloolefin polymer” and like terminology refers to a COP or COC polymer which exhibits a glass transition temperature, but does not exhibit a crystalline melting temperature nor does it exhibit a clear x-ray diffraction pattern.

“COC” polymer and like terminology refers to a cyclolefin copolymer prepared with acyclic olefin monomer and cyclolefin monomer by way of addition copolymerization.

“COP polymer” and like terminology refers to a cycloolefin containing polymer prepared exclusively from cycloolefin monomer, typically by ring opening polymerization.

Molecular weight of the amorphous cycloolefin copolymer is determined by means of gel permeation chromatography (GPC) in chloroform at 35° C., with the aid of an IR detector; the value is relative and based on a calibration using narrow-distribution polystyrene standards. The molecular weight of the cycloolefin polymers or copolymers can be controlled in a known manner by introduction of hydrogen, variation of the catalyst concentration or variation of the temperature. Molecular weight of the partially crystalline cycloolefin elastomers is measured by high temperature molar mass GPC in 1,2,4-trichlorobenzene at 140° C. using an appropriate standard and IR detector. Unless otherwise indicated, molecular weight refers to the weight average molecular weight.

Melt Volume Rate is measured in accordance with ISO Test Method 1133 at a load of 2.16 kg and a temperature of 260° C. for the partially crystalline cycloolefin elastomer and at a temperature of 230° C. for the amorphous cycloolefin polymer.

“Melt-blended” and like terminology refers to a process whereby polymers which are already formed such as COP, COC and COC elastomers are blended together in a molten state. Preferably, the COP, COC and COC elastomer polymers are substantially unreactive with each other and during the blending process as opposed to processes involving in situ polymerization and/or reaction between rigid polymer and elastomer ingredients as described in U.S. Pat. Nos. 7,026,401; 5,567,776; 5,494,969; 4,874,808; United States Patent Application Publication No. US 2005/0014898 and Japanese Publication No. JP 5271484, the disclosures of which are incorporated herein by reference.

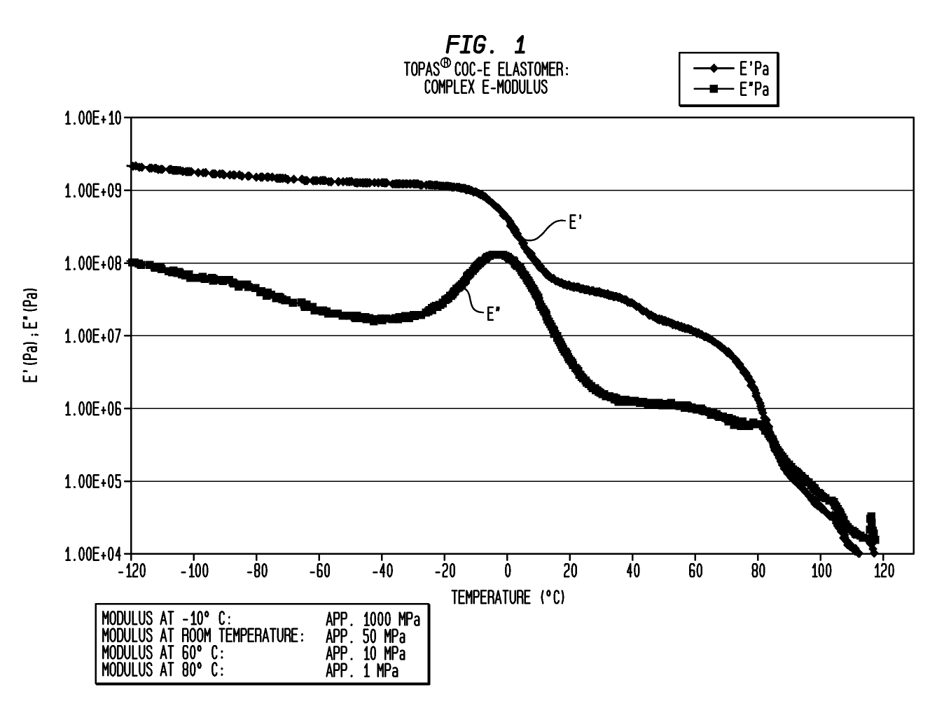

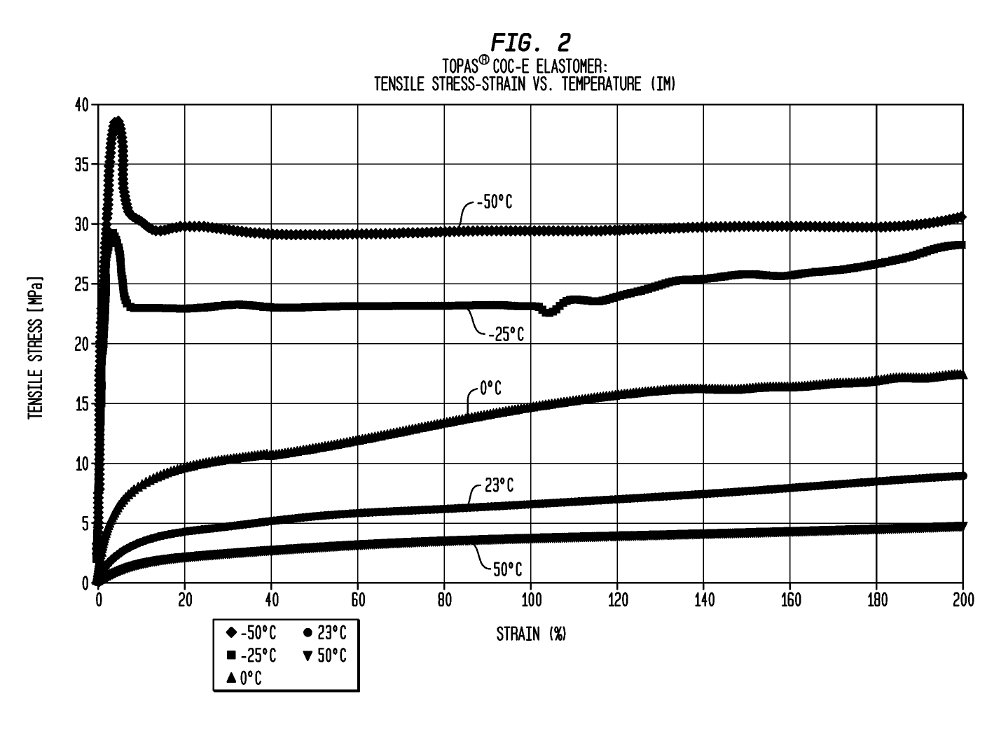

“Partially crystalline cycloolefin elastomer of norborene and ethylene”, and like terminology refers to a partially crystalline elastomer which contains cyclolefin repeat units, exhibits both a glass transition temperature and a melting point and rubbery modulus at room temperature and below. A typical elastomer, for example, is an ethylene/norbornene copolymer elastomer having a norbornene content of about 8-9 mol %, with a target of 8.5 mol %. It is seen hereinafter that partially crystalline COC elastomers may exhibit a rubbery modulus plateau between about 10° C. and 20° C. and 80° C. and 90° C. As to thermal properties and crystallinity, these polymers optionally feature two glass transition temperatures of about 6° C. and below about −90° C. as well as an exemplary crystalline melting point of about 84° C. These polymers exhibit flexibility and elastic behavior, that is, elongation before breaking of up to 200% and more at temperatures as low as −50° C. and below as is discussed herein in connection with FIGS. 1, 2. Unlike amorphous COP and COC polymers, these COC elastomers typically contain between 10 and 30 percent crystallinity. While these materials are typically prepared by the catalytic reaction of norbornene and ethylene as hereafter described, additional monomers may be included if so desired. Likewise, the materials may include grafted on units and crosslinkers if so desired and polymerization techniques such as ring opening metathesis may be employed. Preferably, the partially crystalline, cycloolefin elastomer of norbornene and ethylene is predominantly, more than 50% by weight, norbornene and ethylene repeat units, more preferably more than 80% by weight norbornene and ethylene repeat units and still more preferably, more than 90% by weight norbornene and ethylene repeat units.

A melt-blend of the invention exhibits characteristic localized stress whitening only when it is tested in accordance with ASTM Test Method D3763-08 on a 2 mm thick injection-molded test specimen and stress whitening occurs only contiguously to the puncture. That is, there is no stress whitening at the clamp or other areas in the specimen remote to the puncture. “Localized stress whitening only” thus means that there is no stress whitening spaced apart (remote) from the puncture by this test method. The characteristic localized stress whitening index is calculated from a 2 mm thick test specimen which has been tested in accordance with ASTM Test Method D 3763-08 by measuring the average distance that stress whitening extends from the periphery of the puncture and dividing by the diameter of the probe; that is, 12.7 mm unless specified otherwise. It will be appreciated from the foregoing that exhibiting characteristic localized stress whitening only and a characteristic localized whitening index are inherent properties of the melt-blend and not restricted to any particular use or shaped article.

Unless otherwise indicated, the Tg of the polymers was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis” (American Society for Testing of Materials, Philadelphia, Pa.).

Storage Modulus, E′ and Loss Modulus, E″, are measured by dynamic mechanical analysis (DMA), following ASTM D5026-06 and ASTM D4065-06 Test Methods, employing frequency of 1.0 Hz and a heating rate of 2° C. per minute over a temperature range of from −120° C. to 150° C. Storage or loss modulus may alternatively be measured in accordance with test methods ASTM D5279-08 (torsion) or ASTM D5023-07 (flexure).

Unless otherwise indicated, a Test Method in effect as of Mar. 1, 2010 is utilized.

### Cycloolefin Copolymer Elastomers

COC elastomers are elastomeric cyclic olefin copolymers also available from TOPAS® Advanced Polymers. E-140 polymer features two glass transition temperatures, one of about 6° C. and another glass transition below −90° C. as well as a crystalline melting point of about 84° C. Unlike completely amorphous TOPAS COC grades, COC elastomers typically contain between 10 and 30 percent crystallinity by weight. Typical properties of E-140 grade appears in Table 1:

TABLE 1
E-140 Elastomer Properties

| Property | Value | Unit | Test Standard |
|---|---|---|---|
| Physical Properties | | | |
| Density | 940 | kg/m³ | ISO 1183 |
| Melt volume rate (MVR)- | 3 | cm³/10 min | ISO 1133 |
| @2.16 kg/190° C. | | | |
| Melt volume rate (MVR)- | 12 | cm³/10 min | ISO 1133 |
| @2.16 kg/260° C. | | | |
| Hardness, Shore A | 89 | — | ISO 868 |
| WVTR-@23° C./ 85RH | 1.0 | g*100 μm/m²* day | ISO 15106-3 |
| WVTR-@38° C./ 90 RH | 4.6 | g*100 μm/m²* day | ISO 15106-3 |
| Mechanical Properties | | | |
| Tensile stress at break | <19 | MPa | ISO 527-T2/1A |
| (50 mm/min) | | | |
| Tensile modulus (1 mm/min) | 44 | MPa | ISO 527-T2/1A |
| Tensile strain at break | <450 | % | ISO 527-T2/1A |
| (50 mm/min) | | | |
| Tear Strength | 47 | kN/m | ISO 34-1 |
| Compression set-@24 h/23° C. | 35 | % | ISO 815 |
| Compression set-@72 h/23° C. | 32 | % | ISO 815 |
| Compression set-@24 h/60° C. | 90 | % | ISO 815 |
| Thermal Properties | | | |
| Tg-Glass transition temperature | 6 | ° C. | DSC |
| (10° C./min) | <−90 | | |
| Tₘ-Melt temperature | 84 | ° C. | DSC |
| Vicat softening | 64 | ° C. | ISO 306 |
| temperature, VST/A50 | | | |

As seen above, E-140 has multiple glass transitions (Tg); one occurs at less than −90° C. and the other occurs in the range from −10° C. to 15° C.

There is shown in FIG. 1 a plot of Storage Modulus, F and Loss Modulus, E″, versus temperature for E-140 copolymer elastomer having a norbornene content of about 8%-9% (mol %). Testing was conducted following ASTM D5026-06 and ASTM D4065-06 test methods. It is seen the partially crystalline COC elastomer exhibits a rubbery modulus plateau between about 10-20° C. and 80-90° C. The partially crystalline, ethylene/norbornene copolymer elastomer may have a norbornene content of from 1-20 mol % provided performance criteria are met.

It is seen from FIG. 1 that the cycloolefin elastomer exhibits a Storage Modulus between 10⁶ Pa and 10⁸ Pa over a temperature range of from 20° C. to 70° C. The material remains elastic and flexible over a much wider temperature range as can be appreciated from FIG. 2 which provides data for the E-140 grade.

COC elastomer generally has very broad service temperature range, which means the material will retain useful mechanical properties, especially flexibility, from <−90° C. to about 90° C. For example, in FIG. 2, tensile stress-strain of E-140 shows excellent ductility, in excess of 200 percent strain measured at −50° C., −25° C., 0° C., 23° C. and 50° C. E-140 typically exhibits an elongation at break of at least 50%, more typically at least 100% and preferably at least 200% at a temperature of −50° C. Elongation may be measured in accordance with ISO 527-T2/1A or any other suitable method. The upper limit is not precisely known but may be up to 300%, 500% or even 1000% at 0° C.

Under ISO 974: 2000(E) Determination of the Brittleness Temperature by Impact, E-140 did not fail at test temperatures of −50° C., −60° C., −70° C., −80° C. and −90° C. Failure is defined as breakage or any crack visible by the naked eye. Therefore, COC elastomers are suitable for device and packaging applications subject to cryogenic, freezer and refrigerator environments.

TABLE 1A
Low Temperature Brittleness Testing of Elastomer
BRITTLENESS TESTING PROCEDURE:

| Material | E-140 2 mm |
|---|---|
| Test Speed | 2000 ± 200 mm/s |
| Specimen Dimensions | 20 ± 0.25 mm long by 2.5 ± 0.05 mm wide |
| | and 2.0 ± 0.1 mm thick |
| Specimen Preparation | Die Punched from supplied material in machine |
| | direction 3 ± 0.5 minutes at test temperature |
| Test Equipment | Standard Scientific CS-153A-3 |
| Heat Transfer Medium | Methanol |
| Mounting Torque | 5 in-lb |

COC ELASTOMERS likewise have excellent abrasion resistance as is seen in Table 1B:

TABLE 1B
Abrasion resistance testing of Elastomer
ABRASION RESISTANCE TESTING PROCEDURE:

| Material | E-140 2 mm |
|---|---|
| Testing load | 10N |
| Specimen | Circular plaque with diameter of 16 ± 0.25 mm |
| Dimensions | and thickness of 2.0 ± 0.1 mm |
| Specimen Preparation | Punched from supplied material with circular |
| | die with |
| Test Equipment | DIN abrasion tester according to ISO 4649 |

Abrasion resistance of untreated TOPAS Elastomer E-140 is already very good as indicated by the low abrasion volume of 18 ml observed in a test run according to ISO 4649. Crosslinked material has even better mechanical properties as discussed hereinafter.

COC elastomers also have excellent electrical insulating properties. Dielectric constant (or relative permittivity) for E-140 is at or about 2.24, 2.21 and 2.27 at respective frequencies of 1, 5 and 10 GHz. Dissipation factor is at or about 0.00025, 0.00033 and 0.00028 at these same respective frequencies. Testing was conducted in accordance to the guidelines of ASTM D2520-01, Test Method B—Resonant Cavity Perturbation Technique.

Without intending to be bound by any particular theory, it is believed that the suitable COC elastomers have a very low norbornene-ethylene-norbornene (NEN) triad content and have 2 distinct block portions. One set of polymer blocks is thought to have a relatively high norbornene content and cannot crystallize, while another set of polymer block copolymers is thought to have a relatively low norbornene content and can partially crystallize.

Generally, suitable partially crystalline elastomers of norbornene and ethylene include from 0.1 mol % to 20 mol % norbornene, have at least one glass transition temperature of less than 30° C., a crystalline melting temperature of less than 125° C., and 40% or less crystallinity by weight. Particularly preferred elastomers exhibit a crystalline melting temperature of less than 90° C. and more than 60° C. Cycloolefin elastomers useful in connection with the present invention may be produced in accordance with the following: U.S. Pat. Nos. 5,693,728 and 5,648,443 to Okamoto et al.; European Patent Nos. 0 504 418 and 0 818 472 (Idemitsu Kosan Co., Ltd.) and Japanese Patent No. 3350951, also of Idemitsu Kosan Co., Ltd., the disclosures of which are incorporated herein by reference.

Other norbornene/α-olefin copolymer elastomers are described in U.S. Pat. No. 5,837,787 to Harrington et al., the disclosure of which is incorporated herein by reference.

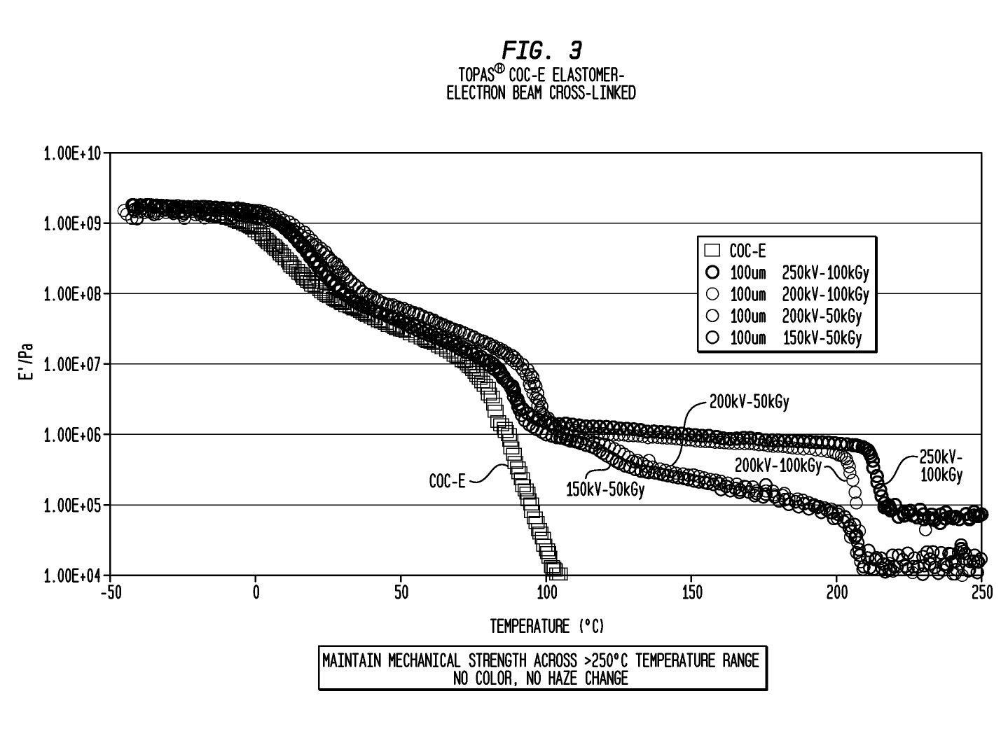

If high temperature performance is desired, the COC elastomer resin may be crosslinked by any suitable method, including with electron-beam (e-beam) radiation or by chemical means known in the art. Crosslinked COC elastomer resins have good optical clarity, are useful in blends, multilayer structures and are also useful in electronic and opto-electronic devices as is appreciated by one of skill in the art. Crosslinking with electron beam radiation extends useful mechanical properties in excess of 250° C. FIG. 3 shows the effect of e-beam cross linking on storage modulus of 100 micron E-140 film under beam energy range of 150-250 kV and radiation dosage range of 50-100 kGy. Significant amount of mechanical strength of non-crosslinked E-140 is lost at 90° C.-100° C. Crosslinking significantly improves and extends mechanical integrity in a range of 200° C. to more than 250° C. Cross-linking does not change transparency, color and haze of E-140 film.

Crosslinked COC elastomers are suitable for use in more aggressive environments. For example, many electrical and optical components used in electronic devices such as mobile phones and photovoltaic panels must be capable to endure 85° C. and 85 percent relative humidity environments. Crosslinked COC elastomers can be used as functional displays, lens, light guides, solar cell encapsulant films and front and back sheet for solar panels. UV resistance of crosslinked material is excellent, extending outdoor exposure without significant change in color and transparency as compared with non-crosslinked materials.

Crosslinked COC elastomers are a good alternative to moisture sensitive thermoplastic polyurethanes. However, crosslinked COC elastomers have a substantial improvement in abrasion resistance and are viable alternatives to polyurethanes for applications requiring high abrasion resistance such as laminate flooring and footwear. Thin films of crosslinked COC elastomers are an excellent laminating material for medical products, sporting equipment and camping gear.

### Amorphous Cyclolefin Containing Polymers

Cycloolefins are mono- or polyunsaturated polycyclic ring systems, such as cycloalkenes, bicycloalkenes, tricycloalkenes or tetracycloalkenes. The ring systems can be monosubstituted or polysubstituted. Preference is given to cycloolefins of the formulae I, II, III, IV, V or VI, or a monocyclic olefin of the formula VII:

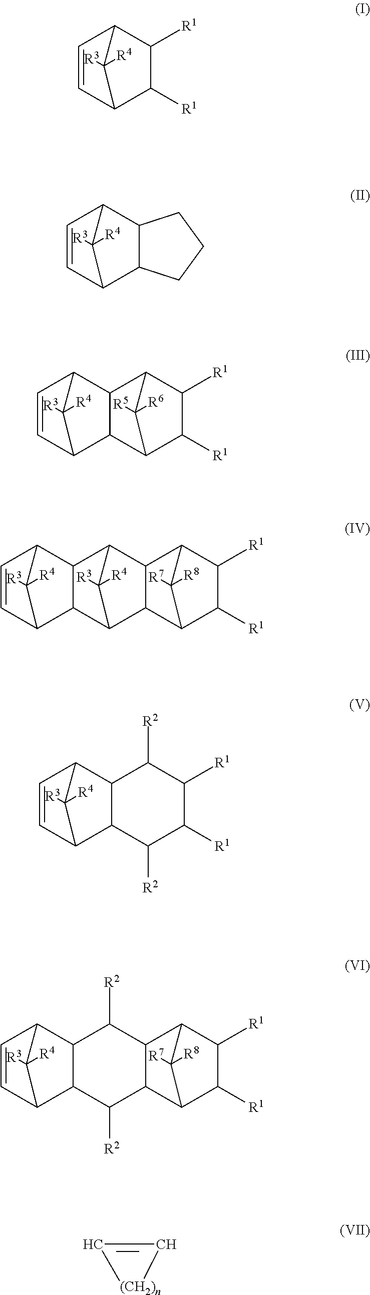

wherein R¹, R², R³, R⁴, R⁵, R⁶, R⁷ and R⁸ are the same or different and are H, a C₆-C₂₀-aryl or C₁-C₂₀-alkyl radical or a halogen atom, and n is a number from 2 to 10.

Specific cycloolefin monomers are disclosed in U.S. Pat. No. 5,494,969 to Abe et al. Cols. 9-27, for example the following monomers:

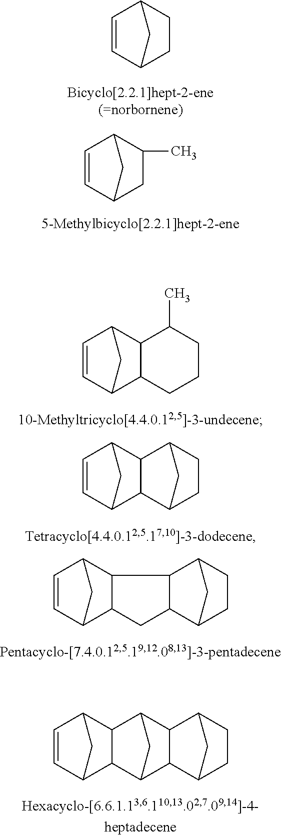

and so forth. The disclosure of U.S. Pat. No. 5,494,969 to Abe et al. Cols. 9-27 is incorporated herein by reference.

The above described cycloolefin monomers are incorporated into either COC or COP material in accordance with Scheme I above.

U.S. Pat. No. 6,068,936 and U.S. Pat. No. 5,912,070 disclose several cycloolefin polymers and copolymers, the disclosures of which are incorporated herein in their entirety by reference. Cycloolefin polymers useful in connection with the present invention can be prepared with the aid of transition-metal catalysts, e.g. metallocenes. Suitable preparation processes are known and described, for example, in DD-A-109 225, EP-A-0 407 870, EP-A-0 485 893, U.S. Pat. Nos. 6,489,016, 6,008,298, as well as the aforementioned U.S. Pat. Nos. 6,608,936, and 5,912,070, the disclosures of which are all incorporated herein in their entireties by reference. Molecular weight regulation during the preparation can advantageously be effected using hydrogen. Suitable molecular weights can also be established through targeted selection of the catalyst and reaction conditions. Details in this respect are given in the abovementioned specifications.

Particularly preferred cycloolefin copolymers include cycloolefin monomers and acyclic olefin monomers, i.e. the above-described cycloolefin monomers can be copolymerized with suitable acyclic olefin comonomers. A preferred comonomer is selected from the group consisting of ethylene, propylene, butylene and combinations thereof A particularly preferred comonomer is ethylene. Preferred COCs contain about 10-80 mole percent of the cycloolefin monomer moiety and about 90-20 weight percent of the olefin moiety (such as ethylene). Cycloolefin copolymers which are suitable for the purposes of the present invention typically have a mean molecular weight M_{w} in the range from more than 200 g/mol to 400,000 g/mol. COCs can be characterized by their glass transition temperature, Tg, which is generally in the range from 20° C. to 200° C., preferably in the range from 30° C. to 130° C. In one preferred embodiment the cyclic olefin polymer is a copolymer such as TOPAS® 8007F-04 which includes approximately 36 mole percent norbornene and the balance ethylene. TOPAS® 8007F-04 has a glass transition temperature of about 78° C. Other preferred embodiments include melt blends of partially crystalline cycloolefin elastomer and amorphous COC materials with low glass transition temperatures. One preferred material for blending with partially crystalline cycloolefin elastomer is TOPAS® 9506F-04 which has a Tg of about 68° C. Still another preferred amorphous COC for blending with partially crystalline cycloolefin elastomer is TOPAS® 9903D-10 which has a glass transition temperature of about 33° C.

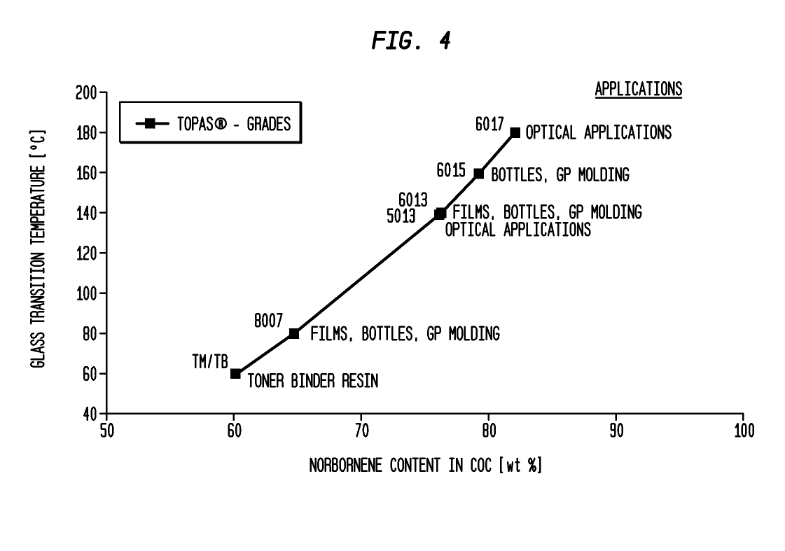

COCs are particularly preferred because their temperature performance can be tailored by changing the cycloolefin content of the polymer. There is shown in FIG. 4 a plot of glass transition temperature versus norbornene content for various commercial grades to TOPAS® COC materials.

Table 2 lists molecular weights of specific COC material and COC elastomer, specifically TOPAS® Elastomer E-140 (“E-140”) material discussed hereinafter.

TABLE 2
Melt Volume Flow Rate and Molecular Weight for TOPAS ® Materials

| | | E- | 9903- | 9506F- | 8007F- | 8007F- | |
|---|---|---|---|---|---|---|---|
| | Units | 140 | D10 | 04 | 04 | 400 | 6013F-04 |
| Melt Volume Rate | ml/10 min | 12 | 8 | — | 32 | — | 14 |
| at 260° C.; 2.16 kg load | | | | | | | |
| Method: ISO 1133 | | | | | | | |
| Melt Volume Rate | ml/10 min | — | 3.3 | 6 | 12 | 11 | 1 |
| at 230° C.; 2.16 kg load | | | | | | | |
| Method: ISO 1133 | | | | | | | |
| WeightAverage | | | | | | | |
| Molecular Weight (Mw) | | | | | | | |
| Chloroform at 35° C. | kg/mol | — | 138 | 114 | 98 | — | 87 |
| 1,2,4 Trichlorobenzol at | kg/mol | 154 | — | — | — | — | — |
| 140° C. | | | | | | | |
| Method GPC | | | | | | | |
| Number Average | | | | | | | |
| Molecular Weight (Mₙ) | | | | | | | |
| Chloroform at 35° C. | kg/mol | — | 42 | 55 | 40 | — | 40 |
| 1,2,4 Trichlorobenzol at | kg/mol | 68 | — | — | — | — | |
| 140° C. | | | | | | | |
| Method GPC | | | | | | | |
| Polydispersity | | 2.26 | 3.29 | 2.07 | 2.45 | — | 2.18 |

Suitable COC material is also available from Mitsui Petrochemical Industries of Tokyo, Japan. Suitable COP materials are available from Zeon Chemicals of Louisville Ky., under the trade name of Zeonex®, or from JSR Corporation of Tokyo, Japan, under the trade name of Arton®.

In addition to the amorphous cycloolefin containing resin and/or partially crystalline cycloolefin elastomer copolymer, suitable additives are used depending upon the desired end-product. Examples of such additives include oxidative and thermal stabilizers, lubricants, release agents, flame-retarding agents, oxidation inhibitors, oxidation scavengers, neutralizers, antiblock agents, dyes, pigments and other coloring agents, ultraviolet light absorbers and stabilizers, organic or inorganic fillers including particulate and fibrous fillers, reinforcing agents, nucleators, plasticizers, waxes, melt adhesives, crosslinkers or vulcanizing agents and combinations thereof. In the Examples which follow, major components of each composition are listed in the tables. Pre-compounded compositions contained the following additives: 0.74% blue (decolorizing), 0.28% Licowax C (internal lubrication) and 0.28% Hostanox 010 (antioxidant).

Multilayer, all-olefin articles can likewise be produced using the inventive compositions blended with or combined with layers of other polyolefins. Polyolefin polymers suitable for blending or combination include polyethylenes, polypropylenes, polybutenes, polymethylpentenes and so forth and are well known in the art. See Kirk-Othmer Encyclopedia of Chemical Technology, 3rd ed., Vol. 16, pp. 385-499, Wiley 1981, the disclosure of which is incorporated herein by reference. Such polymers are readily extruded into films and may be used to produce multilayer films in accordance with the invention as hereinafter described. “Polypropylene” includes thermoplastic resins made by polymerizing propylene with suitable catalysts, generally aluminum alkyl and titanium tetrachloride mixed with solvents. This definition includes all the possible geometric arrangements of the monomer unit, such as: with all methyl groups aligned on the same side of the chain (isotactic), with the methyl groups alternating (syndiotactic), all other forms where the methyl positioning is random (atactic), and mixtures thereof.

Polyethylenes are particularly useful because of their processability, mechanical and optical properties, as well as compatability with the polymer blends of the present invention. Polyethylene layers are typically formed with commercially available polymers and copolymers such as low density polyethylene, linear low density polyethylene (LLDPE), intermediate density polyethylene (MDPE) and high density polyethylene (HDPE). The differences between these materials includes density and degree of branching. LLDPE material generally display higher melting point, higher tensile, higher modulus, better elongation and stress crack resistance than LDPE materials of approximately the same melt index and density. LLDPE and LDPE generally have densities of from 0.90 to 0.94 g/cm³, while MDPE and HDPE typically have densities in the range of from 0.925-0.95 and >0.94 g/cc, respectively. Polyethylene is a semicrystalline thermoplastic whose properties depend to a major extent on the polymerization process (Saechtling, Kunststoff-Taschenbuch [Plastics Handbook], 27^{th} edition).

HDPE typically has a density of greater or equal to 0.941 g/cc. HDPE has a low degree of branching and thus stronger intermolecular forces and tensile strength. HDPE can be produced by chromium/silica catalysts, Ziegler-Natta catalysts or metallocene catalysts. The lack of branching is ensured by an appropriate choice of catalyst (e.g. Chromium catalysts or Ziegler-Natta catalysts) and reaction conditions.

LDPE typically has a density in the range of 0.910-0.940 g/cc. LDPE is prepared at high pressure with free-radical initiation, giving highly branched PE having internally branched side chains of varying length. Therefore, it has less strong intermolecular forces as the instantaneous-dipole induced-dipole attraction is less. This results in a lower tensile strength and increased ductility.

LLDPE is a substantially linear polyethylene, with significant numbers of short branches, commonly made by copolymerization of ethylene with short-chain α-olefins (e.g. copolymerization with 1-butene, 1-hexene, or 1-octene yield b-LLDPE, h-LLDPE, and o-LLDPE, respectively) via metal complex catalysts. LLDPE is typically manufactured in the density range of 0.915-0.925 g/cc. However, as a function of the α-olefin used and its content in the LLDPE, the density of LLDPE can be adjusted between that of HDPE and very low densities of 0.865 g/cc. Polyethylenes with very low densities are also termed VLDPE (very low density) or ULDPE (ultra low density). LLDPE has higher tensile strength than LDPE and exhibits higher impact and puncture resistance than LDPE. Lower thickness (gauge) films can be blown compared to LDPE, with better environmental stress cracking resistance compared to LDPE. Lower thickness (gauge) may be used compared to LDPE. Metallocene metal complex catalysts can be used to prepare LLDPEs with particular properties, e.g. high toughness and puncture resistance. Polyethylenes which are prepared with metallocene catalysts are termed “m-LLDPEs”. The variability of the density range of m-LLDPEs is similar to that of the density range of LLDPE, and grades with extremely low densities are also termed plastomers.

“MDPE” is polyethylene having a density range of 0.926-0.940 g/cc. MDPE can be produced by chromium/silica catalysts, Ziegler-Natta catalysts or metallocene catalysts. MDPE has good shock and drop resistance properties. It also is less notch sensitive than HDPE, stress cracking resistance is better than HDPE.

In the case of all of the types of polyethylene, there are commercial grades with very different flowabilities. Molecular weight can be lowered via control of the chain-termination reaction to such an extent that the product comprises waxes. HDPE grades with very high molecular weights are termed HMWPE and UHMWPE.

Multilayered articles may be produced by co-extrusion. Co-extrusion is a well known process. U.S. Pat. Nos. 3,479,425; 3,959,431; and 4,406,547, the disclosures of which are incorporated herein by reference, describe co-extrusion processes. Medical tubing as described generally in U.S. Pat. No. 6,303,200 to Woo et al. was fabricated from the E-140, partially crystalline elastomer described above, alone or blended and/or layered with amorphous cycloolefin copolymer. The disclosure of U.S. Pat. No. 6,303,200 is incorporated herein by reference.

It has been unexpectedly found that if the tube wall has sufficient thickness, kink resistant tubing can be made with cyclolefin copolymer elastomer. Tubings were prepared from:
E-140
C09-10-5 (85/15 9506F-04/E-140)
C09-10-8 (40/40/20 9506F-04/6013M-07/E-140)
   The initially planned embodiments had dimensions of 0.100-inch ID and 0.138-inch OD; wall thickness of 0.015-inch.

All three of the above materials were successfully extruded into single lumen, monolayer tubing. These were done on a 1-inch extrusion line.

All samples were evaluated for kinking. Tubes are slowly bent together until kinked. PVC tubing does not kink. Kinking resistance is an important property because a kink will restrict and pinch off flow through the tube as noted above. C09-10-5 and C09-10-8 kinked readily after slight bending. Distortion and a heavy crease remained in the tube wall after releasing the kink. E-140 kinked too, however, this material nearly recovered its original shape after releasing the kink.

Additional embodiments included the following layer configuration and layer ratios:
E-140/C09-10-5/E-140 (Uniform wall thickness ratio: 1:1:1)
C09-10-8/E-140/C09-10-5
(Uniform Wall Thickness Ratio: 1:1:1)
E-140/C09-10-5/E-140 (Wall thickness ratio of 1:2:1)
C09-10-8/E-140/C09-10-5 (Wall thickness ratio of 1:2:1)
   Dimensions of 0.100-inch ID and 0.138-inch OD; wall thickness of 0.015-inch were made.

Single lumen, three layer tubing was run on three ¾-inch extruders. Temperature profile used on all extruders from feed to die: 410, 410, 420 and 425° F.; adaptor and clamp 425° F. and die 425° F. Feed throats were cooled to 70° F.

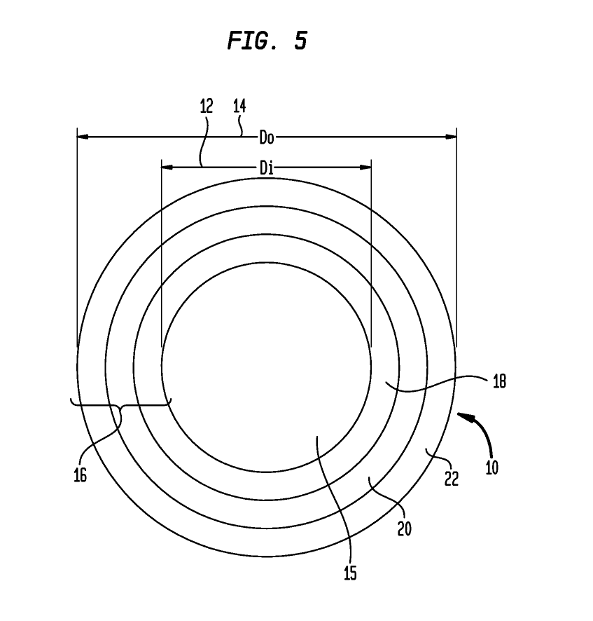

Single lumen, multilayer tubing with a thicker sidewall has the structure shown schematically in FIG. 5 where there is shown in cross-section a cylindrical, single lumen tube 10 with an inside diameter 12 of, for example, about 0.1 inches and an outside diameter 14 of, for example, 0.18 inches around lumen 15. A three-layer wall 16 similarly has a thickness of about 0.040 inches and includes a first layer 18 on the inside of the tube, a medial layer 20 and an outer layer 22. The layers may have various compositions, for example, one or more layers may contain or consist essentially of a partially crystalline, cycloolefin elastomer of norbornene and ethylene, while the other layers may consist of polyethylene or polypropylene. At least one layer contains a partially crystalline, cycloolefin elastomer which may be melt blended, for example, with an amorphous cycloolefin containing polymer. The various layers may be of uniform thickness as shown or it may be preferred to vary the thicknesses depending upon materials and desired properties.

Since E-140 monolayer tubing appeared promising, additional runs were made.

Wall thickness E-140 tubing with constant ID of 0.100-inch was increased in 0.005-inch increments from 0.015 to 0.040-inch. As the wall thickness increased, kink resistance improved. Wall thickness of 0.035 and 0.0400-inch was sufficient to make the tube kink resistant.

Kink resistance is both tube geometry and material dependent as is seen from the following data which include monolayer specimens from the foregoing trials:

### E-140

ID: 0.096-inch
OD: 0.138-inch
Wall: 0.020-inch (20-mil) (Kinked)

### E-140

ID: 0.117-inch
OD: 0.181-inch
Wall: 0.030-inch (30-mil) (Kinked)

### E-140

ID: 0.108-inch
OD: 0.185-inch
Wall: 0.040-inch (40-mil) (no Kink)
All 100% E-140 tubes are very flexible.
E-140 tubing with 15, 25 and 35-mil wall thickness were also prepared. 35-mil is kink resistant, thinner walled tubes are not.
Other comparative samples were made at the following dimension (This geometry is common for PVC tubing which is kink resistant):
ID: 0.100-inch
OD: 0.138-inch
Wall: 0.015-inch (15-mil)

### C09-10-5: (85/15 9506F-04/E-140)

### C09-10-8: (40/40/20 9506F-04/6013M-07/E-140)

C09-10-5 and C09-10-8 tubes are very stiff.
All tubing was monolayer in the comparative blend examples immediately above.
Tube geometry is application specific. Current trends include smaller diameter, soft feel and high flow.

While single lumen tubing was tested, one of skill in the art will appreciate that multi-lumen tubing is readily prepared as well.

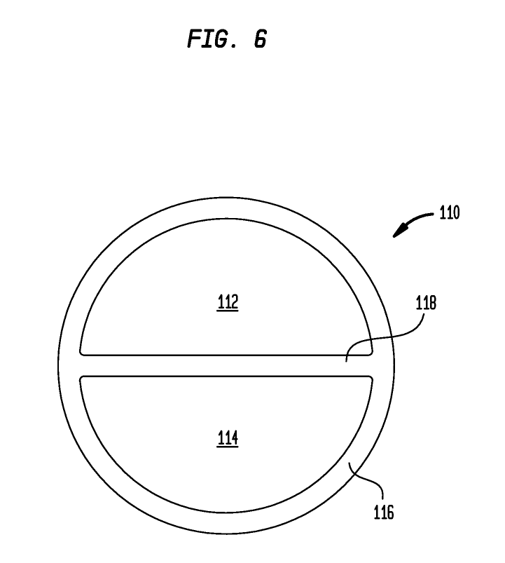

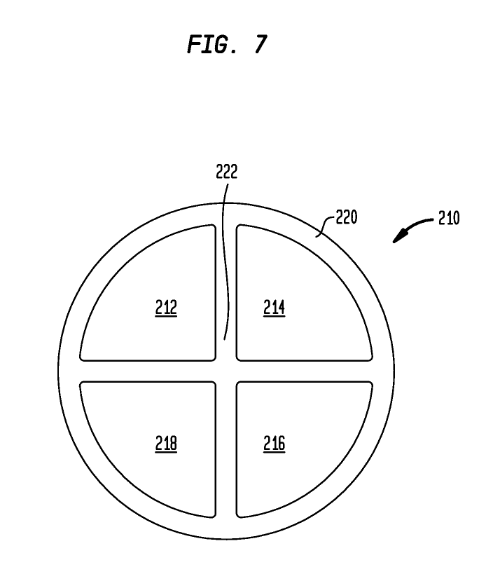

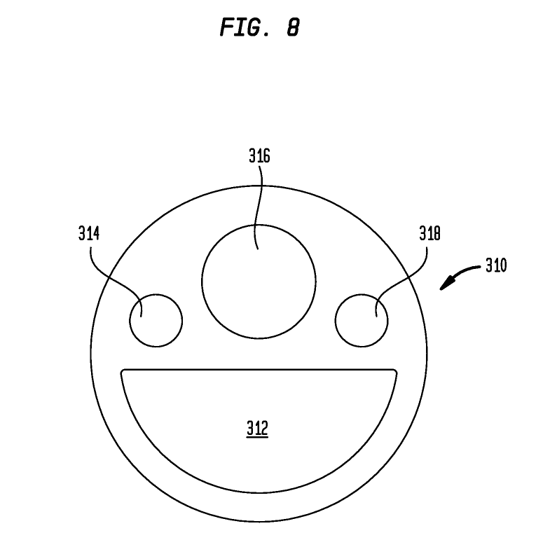

Multi-lumen tubes may have the structure shown in FIG. 6, FIG. 7, FIG. 8, or a multitude of other geometries as will be appreciated by one of skill in the art. There is shown in FIG. 6 a cylindrical tube 110 having two lumens 112, 114, an outer wall 116 and an internal dividing wall 118. FIG. 7 similarly shows a four lumen construction of a tube 210 with lumens 212, 214, 216, 218 as well as an outer wall 220 and an internal divider 222 which defines the four lumens. In the embodiment shown in FIG. 7, the four lumens are of equal cross-section but other geometries may be utilized as shown in FIG. 8. In FIG. 8, there is shown a four lumen tube 310 having in one-half of the tube a large lumen 312 of semi-circular cross-section as well as smaller lumens 314, 316 and 318 which may be of the same or different size.

The tube structures shown in FIGS. 5, 6, 7 and 8 are readily prepared on conventional extrusion equipment. For structures other than single lumen tubes, the inside diameter and/or inside diameter/wall thickness ratio is calculated by disregarding internal dividing walls such as wall 116 of FIG. 6 and divider 222 of FIG. 7. For more complex structures as shown in FIG. 8, the inside diameter/wall thickness ratio is calculated by dividing the largest cross-sectional dimension of the largest lumen by the average wall thickness around that lumen. Likewise, for complex structures, the wall thickness is taken as the average wall thickness around the largest lumen of the structure.

The articles of the present invention exhibit elastic properties suitable for use with elastomer closures and for attachment and sealing to housings, fittings, tubings, medical containers, medical apparatus and so forth. The present invention also includes as an apparatus medical tubing of the present invention attached to or connected with such structures and associated articles including, without limitation: tubing attachments, fittings, fitments, and closures such as elastomer closures; tubing fittings; compression fittings; nuts; ferrules; grippers; grab seals; adapters, male and female; elbows; valves; pumps; tips; medical bellows; wipers; harness wraps; specialty protection covering and catheters for short term tissue contact, for example, ambulatory peritoneal dialysis catheters. The medical tubing of the invention will self-seal or bond mechanically and/or chemically to connecters and so forth, preferably without the use of adhesives or solvents. Combinations with polyester, polycarbonate or other polyolefin parts are particularly suitable. Bonding can be carried out or enhanced during sterilization by pressurized steam, for example, as is practiced with medical devices and containers.

The partially crystalline, cycloolefin elastomers utilized in connection with the present invention may also be used to fabricate the shaped article products and components enumerated above; either alone or in a layer or blended construction or as a component of the product. Additional shaped article products and components which may be so constructed include, without limitation: syringes; bellows in general, protective harnesses; bladders; elastomeric closures, optionally pierceable elastomeric closures; reservoirs; protective sleeves and coverings; dispensers; flanges; scaffolds and tubes for cell growth and storage; soft touch grips for instruments such as surgical instrument handles for tactile feel especially effective in wet environments to enhance grip (non-slip); these instruments can be assembled by overmolding onto TOPAS® standard grades or other olefins, which retains purity and offers a low cost option compared to other TPE's such as Santoprene® and retains purity, instead of using of using adhesives or harsh chemical solvents to achieve bonding. The partially crystalline elastomer is likewise suitable for making flexible molds for food products and contact lenses; trays; casings; boots; sleeves; cuffs; hose and tubes, in general; couplings and connectors; valves; filters; stretch type hose with annular or spiral convolutions; accordion bellows used for protection for items such as screws, shafts and slide ways for protection from debris; hydraulic and pneumatic seals; packings; filters; clamps; gaskets; fasteners; mounting clips with seal features; o-rings; belts; splash guards; bumpers and components, therefor; as well as protective coverings and sleeves for containers such as bottles for chemicals and the like to enhance impact and abrasion resistance.

The shaped articles of the invention herein described are formed by extrusion, coextrusion, thermoforming, blow molding, injection molding, compression molding or injection-compression molding.

In one application, contact lens molds may be fabricated with the partially crystalline, cycloolefin elastomer utilized in connection with the present invention either alone or layered or blended with other materials. Suitable apparatus and techniques are disclosed in United States Patent Application Publication No. US 2007/0216860, the disclosure of which is incorporated herein by reference. The following references, also incorporated herein by reference, provide further information as to operating and techniques for using the material in contact lens molds and manufacture of the lenses: U.S. Pat. Nos. 6,772,988 and 6,827,885, both to Altmann et al, teach methods and devices to control optical device polymerization; United States Patent Application Publication No. US 2004/0075039; U.S. patent application Ser. No. 11/930,709, published as US 2008/0064784; U.S. Pat. No. 5,882,698 to Su et al.; U.S. Pat. No. 7,320,587 to Goodenough et al.; U.S. Pat. Nos. 4,921,205; 5,540,410; 6,316,560; and 6,551,531 provide additional material pertinent to the background of the contact lens mold art. The latter references generally teach that polypropylene, polyethylene and/or cycloolefins can be used to make the molds for contact lenses. The materials disclosed herein may readily be substituted therefor.

In other applications, the partially crystalline, cycloolefin elastomer containing materials may be used to fabricate eyedroppers and eyedropper components as described in United States Patent Application Publication No. US 2007/0233020, entitled “Cannula Tip Eye prop Dispenser”. Note FIG. 19, eyedropper 110 and the various components thereof. The flexible material of this invention may be used to fabricate a flexible bulb such as bulb 116. The disclosure of United States Patent Application Publication No. US 2007/0233020 is incorporated herein by reference.

In still other aspects, the partially crystalline, cycloolefin elastomer containing materials are also used to fabricate collapsible squeeze tubes and components as described in United States Patent Application Publication No. US 2007/0116509, entitled “Collapsible Squeeze Tube”. The disclosure of United States Patent Application Publication No. US 2007/0116509 is incorporated herein by reference.

The partially crystalline, cycloolefin elastomer containing materials are still further used to fabricate squeeze bottles with or without pumps and components as described in United States Patent Application Publication No. US 2009/0242588, entitled “Squeeze Bottle and Pump Combination”. The disclosure of United States Patent Application Publication No. US 2009/0242588 is incorporated herein by reference.

In connection with still yet further additional products, the partially crystalline, cycloolefin elastomer containing materials are used to fabricate shrink film and shrink tubing which may optionally be used in medical applications. With respect to film, see U.S. Pat. No. 6,872,462 to Roberts et al.; U.S. Pat. No. 6,579,584 to Compton; U.S. Pat. No. 5,962,092 to Kuo; U.S. Pat. No. 6,051,305 to Hsu, U.S. Pat. No. 6,984,442 to Brebion, and U.S. Pat. No. 7,051,493 to Cook; U.S. Pat. No. 5,654,386 and U.S. Pat. No. 5,658,998, both to Minami et al.; as well as U.S. Pat. No. 5,532,030 to Hirose et al., the disclosures of which are incorporated herein by reference. With respect to shrink tubes, see U.S. Pat. No. 7,674,421 to Ross and U.S. Pat. No. 7,540,776 to Graeve et al., the disclosures of which are also incorporated herein by reference.

From the foregoing discussion, it will be apparent to one of skill in the art that the articles of the invention may be utilized in a variety of applications, including those enumerated above and those additionally discussed below.

### Single-Use Bioprocessing Tubing, Film Bulk Bags, Bag Liners, and Injection Molded or Sheet Fabricated Accessories

COC-E and COC-E blends with olefins and other polymers in monolayer and multilayer tubing, film bags, bag liners, including bulk bags, injection molded and sheet fabricated components i.e. tanks have reduced protein adsorption compared to other substrates and are well suited for bioprocessing proteins, peptides for injectables at low temperature (−40C). COC-E and blends with TOPAS are ultra pure (non-cytotoxic, non-pyrogenic and non-hemolytic).

The new Disposable BioProcessing Single-Use Systems used to manufacture drugs are smaller and portable where drugs are manufactured locally and marketed globally. Disposable Single-Use Bioprocessing offer benefits in plastic over large stainless steel manufacturing trains. COC-E benefits include: extremely low adsorption compared to other polymer substrates and compared to stainless steal—ease and speed of change over, elimination of 8 hours of cleaning, no chance of cross contamination, lower cost and lower biofootprint to discard plastic than wash out stainless steel systems.

COC-E in bioprocess bulk bags and bag liners used for making proteins/peptides for injectables, do not have the issues bulk bags used for processing drugs have today including: cryogenic freezing bags fail flash freezing at −80 to −60° C. (bags shatter & crack in the fast freeze), EVA film sticks to itself making processing difficult, and issues in adsorption, autoclaving and sterilization and chemical resistance.

### Bulk Containers for Active Pharmaceutical Ingredients (API) and Food for Manufacturing and Transport

In addition to drug containers only a few cc in volume, COC-E and COC-E blends enable the manufacturing of very large size containers for blow molding and injection molding that are shatter-resistant and pure with very low leachables and extractables. COC-E and COC-E blends including TOPAS COC, olefins and other resins in monolayer or multilayer blow molded bottles, two-shot injection molded and over-molded bottles, used for making active pharmaceutical ingredient (API) containers for drug and food storage for glass replacement.

Bulk containers, such as API bulk containers are one liter in size and go up to many gallons depending on the drug or food manufactured. COC-E and blends made into containers and closure systems used to store and ship active pharmaceutical ingredients (API) and food from manufacturing in powder and liquid form for drugs, generic drugs, biosimilars and food. This includes containers that may be in direct contact with dry ice. Containers and closure systems can not have a detrimental effect on the API or food chemistry. Reliable closures and containers systems reduce the risk of drug contamination, tamper resistance and counterfeiting.

### Thermal Bonding of Medical Devices

COC-E and COC-E blends for thermal bonding of medical devices that bond to fiber, such as face masks, and cloth. These include disposable wear like diapers, masks, medical tape and surgical clothing including gowns, caps, and masks. Thermal bonding, binder bonding, combined bonding, spunlace bonding can use the flexibility of COC-E in production including various tubular medical devices. COC-E can be used in the manufacture of non woven webs that require flexible fiber fusion. Thermal bonding is more economical than chemical binders and the low density of COC-E at 0.94 g/cc can offer a weight savings over other materials.

### Baby Bottles, Breast Pump Components, Sippy Cups, Pacifiers, Teething Rings, Water and Food Containers

Having low leachables and extractables, COC-E resin is suited for baby bottles, sippy cups, pacifiers, teething rings, and portable water bottles. In addition, COC-E is good for water and food containers and closures in general due to the high purity, and good clarity of COC-E resin in blow molded, injection molded, and extruded applications. COC-E does not have any estrogenic affect as other polymers can.

It will be appreciated from the foregoing that a wide variety of articles may be made with the new partially crystalline, cycloolefin elastomers. For example, pharmaceutical and OTC unit dose packaging delivery systems are made with or from E-140 and E-140 blends with TOPAS® standard grades and other olefins. Likewise, special delivery oral drugs, squeezable blow molded eye dropper bottles, liquid medical dispensers including dosing syringes, inhalers, measured droppers and spoons, and topical applicators are produced with the new elastomers and blends.

Particular applications for the new materials described herein include pump delivery devices including their tubing and components such as infusion pumps to infuse liquid medication or nutrients into a patient's body, either intravenously or subcutaneously. The inventive devices and apparatuses allow administration of fluids to be extremely minute, less than a drop, at 0.1 mL per hour. Metered dosing of all types, including adjustable flow rates for liquids requiring very precise amounts are facilitated with the devices of the present invention, whereas the cost of manual administration of multiple doses are frequently prohibitive.

Diaphragm pumps with repeated compression/decompression with an inlet check valve during decompression and an outlet check valve are made with materials described herein as are peristaltic pumps for flexible tubing compression to push liquid inside flexible tubing that can be used at lower pressures. Partially crystalline cycloolefin elastomers can also be used in filtering devices of all types for body fluids as well as containers, cartridges, vials, bottles and syringes used with the above mentioned pumping or filtering devices.

Aspirator devices used to suction, which are devices to remove liquids by suction such as serum, or mucus include partially crystalline cycloolefin elastomers in their construction. These devices could be used with a suction pump to create a partial vacuum.

Also included within the scope of the present invention is medical device packaging that requires bonding or use of the material with paper, non-wovens, cloth, film, sheet or rigid trays offering fiber-free, easy-peel, tamper evident/anti-counterfeit seals made from partially crystalline cycloolefin elastomers and blends containing them as well as coated papers with peelable seal coatings. Partially crystalline cycloolefin elastomers and blends with other materials can be used to bond components together in a heat seal process without residual solvents that may be left behind by solvent-based sealants and adhesives. These have the ability to withstand sterilization processes such as EtO (ethylene oxide), gamma and electron beam irradiation, hydrogen peroxide gas plasma, and pulsed light. Surgical drapes, wraps, masks and protective products comprising different shaped designs and textures are produced in connection with the present invention.

Sealants and coatings used in packaging for the food and beverage industry, such as coatings and sealants for metal cans, paperboard cans and glass jars are also made with partially crystalline cycloolefin elastomers according to the present invention.

It was discovered that COC elastomers are surprisingly effective as compatibilizers in blends of amorphous cycloolefin polymers and thermoplastic elastomers. One aspect of the invention is thus articles made from melt-blended resin compositions prepared by melt-blending:
(a) from 60 parts to 94.5 parts per hundred weight resin in the blend of an amorphous cycloolefin polymer composition exhibiting a glass transition temperature (Tg) in the range of from 30° C. to 200° C.;
(b) from 30-5 parts by weight of a thermoplastic elastomer; and
(c) from 10 parts to 0.5 or less part per hundred weight resin in the blend of a partially crystalline, cycloolefin elastomer of norbornene and ethylene having at least a first glass transition temperature (Tg) in the range of from −10° C. to 15° C. and optionally having a second glass transition temperature (Tg) less than −90° C. as well as a crystalline melting temperature in the range of from 60° C. to 125° C. and a % crystallinity by weight in the range of from 5% to 40%.

Suitable elastomeric materials for use in combination with COC-E and amorphous cycloolefin containing polymers are described in Kirk-Othmer Encyclopedia of Chemical Technology, 3^{rd} Ed., Vol. 8 pp. 626-640, the disclosure of which is incorporated herein by reference. Such materials include, without limitation, olefinic thermoplastic elastomers; polyamide thermoplastic elastomer; polybutadiene thermoplastic elastomer, e.g., syndiotactic 1,2-polybutadiene thermoplastic elastomer; polyester thermoplastic elastomer; polyurethane thermoplastic elastomer, e.g., thermoplastic polyester-polyurethane elastomer, and thermoplastic polyether-polyurethane elastomer; styrenic thermoplastic elastomer; vinyl thermoplastic elastomer, e.g., polyvinyl chloride polyol (pPVC). Particularly preferred in many cases due to optical characteristics and/or blend compatibility are styrene block copolymer elastomers such as styrene/butadiene block copolymers (SBS), styrene/ethylene/butadiene block copolymers (SEBS), styrene/isoprene block copolymers (SIS) and styrene/ethylene/propylene block copolymers (SEPS).

### Additional Embodiments

In additional aspects of the invention, there is provided shaped articles formed from the melt blends of embodiments 1-61 or incorporating a layer formed of the melt blends of embodiments 1-61 or incorporating a polymer described in embodiments 1-61.

Embodiment No. 1 is a melt-blend resin composition prepared by melt-blending: (a) from 60 parts to 99 parts per hundred weight resin in the blend of an amorphous cycloolefin polymer composition exhibiting a glass transition temperature (Tg) in the range of from 30° C. to 200° C.; and (b) from 40 parts to 1 part per hundred weight resin in the blend of a partially crystalline, cycloolefin elastomer of norbornene and ethylene having at least one glass transition temperature (Tg) of less than 30° C., a crystalline melting temperature of less than 125° C. and a % crystallinity by weight of 40% or less.

Embodiment No. 2 is the melt-blend resin composition according to Embodiment No. 1, wherein the blend contains from 65 parts to 97.5 parts per hundred weight resin in the blend of the amorphous cycloolefin copolymer composition exhibiting a glass transition temperature in the range of from 30° C. to 200° C. and from 35 parts to 2.5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 3 is the melt-blend resin composition according to Embodiment No. 1, wherein the blend contains from 75 parts to 95 parts per hundred weight resin in the blend of the amorphous cycloolefin copolymer composition exhibiting a glass transition temperature in the range of from 30° C. to 200° C. and from 25 parts to 5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 4 is the melt-blend resin composition according to Embodiment No. 1, wherein the blend contains from 85 parts to 92.5 parts per hundred weight resin in the blend of the amorphous cycloolefin copolymer composition exhibiting a glass transition temperature in the range of from 30° C. to 200° C. and from 15 parts to 7.5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 5 is the melt-blend resin composition according to Embodiment No. 1, wherein the blend contains from 77.5 parts to 82.5 parts per hundred weight resin in the blend of the amorphous cycloolefin copolymer composition exhibiting a glass transition temperature in the range of from 30° C. to 200° C. and from 17.5 parts to 22.5 parts per hundred weight of the partially crystalline cycloolefin elastomer of norbornene and ethylene having at least one glass transition temperature (Tg) of less than 30° C., a crystalline melting temperature of less than 125° C. and a % crystallinity by weight of 40% or less.

Embodiment No. 6 is the melt-blend resin composition according to Embodiment No. 1, wherein the amorphous cycloolefin copolymer composition has a Tg in the range of from 40° to 150° C.

Embodiment No. 7 is the melt-blend resin composition according to Embodiment No. 1, wherein the amorphous cycloolefin copolymer composition has a Tg in the range of from 100° to 135° C.

Embodiment No. 8 is the melt-blend resin composition according to Embodiment No. 1, wherein the amorphous cycloolefin copolymer composition has a Tg in the range of from 30° to 70° C.

Embodiment No. 9 is the melt-blend resin composition according to Embodiment No. 1, wherein the amorphous cycloolefin copolymer composition has a Tg in the range of from 30° to 40° C.

Embodiment No. 10 is the melt-blend resin composition according to Embodiment No. 1, wherein the partially crystalline elastomer of norbernene and ethylene has at least one glass transition temperature (Tg) in the range of from −10° C. to 15° C. and a crystalline melting temperature in the range of from 60° C. to 125° C. and a % crystallinity by weight in the range of from 2.5% to 40%.

Embodiment No. 11 is the melt-blend resin composition according to Embodiment No. 10, wherein the partially crystalline elastomer of norbornene and ethylene has at least one glass transition temperature (Tg) in the range of from 0° to 10° C.

Embodiment No. 12 is the melt-blend resin composition according to Embodiment No. 10, wherein the partially crystalline, cycloolefin elastomer of norbornene and ethylene exhibits at least one glass transition temperature (Tg) in the range of from −10° C. to 15° C. and at least a second glass transition temperature (Tg) at less than −90° C.

Embodiment No. 13 is the melt-blend resin composition according to Embodiment No. 1, wherein the partially crystalline elastomer of norbornene has a Melt Volume Rate @ 230° C. and 2.16 kg load of from 0.25 to 25.

Embodiment No. 14 is the melt-blend resin composition according to Embodiment No. 10, wherein the partially crystalline elastomer of norbornene has a Melt Volume Rate @ 230° C. and 2.16 kg load of from 0.5 to 2.

Embodiment No. 15 is the melt-blend resin composition according to Embodiment No. 10, wherein the partially crystalline elastomer of norbornene has a Melt Volume Rate @ 230° C. and 2.16 kg load of from 2.5 to 4.5.

Embodiment No. 16 is the melt-blend resin composition according to Embodiment No. 10, wherein the partially crystalline elastomer of norbornene has a Melt Volume Rate @ 230° C. and 2.16 kg load of from 4 to 8.

Embodiment No. 17 is the melt-blend resin composition according to Embodiment No. 10, wherein the partially crystalline elastomer of norbornene has a Melt Volume Rate @ 230° C. and 2.16 kg load of from 8 to 15.

Embodiment No. 18 is the melt-blend resin composition according to Embodiment No. 10, wherein the partially crystalline elastomer of norbornene and ethylene has a melting temperature in the range of from 70° to 100° C.

Embodiment No. 19 is the melt-blend resin composition according to Embodiment No. 10, wherein the partially crystalline elastomer of norbornene and ethylene has a melting temperature in the range of from 80° to 90° C.

Embodiment No. 20 is the melt-blend resin composition according to Embodiment No. 10, wherein the partially crystalline elastomer of norbornene and ethylene has a % crystallinity by weight in the range of from 5% to 40%.

Embodiment No. 21 is the melt-blend resin composition according to Embodiment No. 10, wherein the partially crystalline elastomer of norbornene and ethylene has a % crystallinity by weight in the range of from 10% to 30%.

Embodiment No. 22 is the melt-blend resin composition according to Embodiment No. 10, wherein the partially crystalline elastomer of norbornene and ethylene has a norbornene content in the range of from 3 mol % to 20 mol %.

Embodiment No. 23 is the melt-blend resin composition according to Embodiment No. 10, wherein the partially crystalline elastomer of norbornene and ethylene has a norbornene content in the range of from 5 mol % to 15 mol %.

Embodiment No. 24 is the melt-blend resin composition according to Embodiment No. 10, wherein the partially crystalline elastomer of norbornene and ethylene has a norbornene content in the range of from 7 mol % to 11 mol %.

Embodiment No. 25 is the melt-blend resin composition according to Embodiment No. 10, wherein the partially crystalline elastomer of norbornene and ethylene has a weight average molecular weight in the range of from 25,000 to 500,000 Daltons.

Embodiment No. 26 is the melt-blend resin composition according to Embodiment No. 10, wherein the partially crystalline elastomer of norbornene and ethylene has a weight average molecular weight in the range of from 50,000 to 450,000 Daltons.

Embodiment No. 27 is the melt-blend resin composition according to Embodiment No. 10, wherein the partially crystalline elastomer of norbornene and ethylene has a weight average molecular weight in the range of from 75,000 to 300,000 Daltons.

Embodiment No. 28 is the melt-blend resin composition according to Embodiment No. 10, wherein the partially crystalline elastomer of norbornene and ethylene has a weight average molecular weight in the range of from 100,000 to 200,000 Daltons.

Embodiment No. 29 is the melt-blend resin composition according to Embodiment No. 10, wherein the partially crystalline elastomer of norbornene and ethylene exhibits a Melt Volume Rate @ 260° C. and 2.16 kg load of from 2 ml/10 min to 50 ml/10 min.

Embodiment No. 30 is the melt-blend resin composition according to Embodiment No. 10, wherein the partially crystalline elastomer of norbornene and ethylene exhibits a Melt Volume Rate @ 260° C. and 2.16 kg load of from 4 ml/10 min to 35 ml/10 min.

Embodiment No. 31 is the melt-blend resin composition according to Embodiment No. 10, wherein the partially crystalline elastomer of norbornene and ethylene exhibits a Melt Volume Rate @ 260° C. and 2.16 kg load of from 6 ml/10 min to 24 ml/10 min.

Embodiment No. 32 is the melt-blend resin composition according to Embodiment No. 10, wherein the partially crystalline elastomer of norbornene and ethylene exhibits a Melt Volume Rate @ 260° C. and 2.16 kg load of from 8 ml/10 min to 16 ml/10 min.

Embodiment No. 33 is the melt-blend resin composition according to Embodiment No. 1, wherein the partially crystalline elastomer exhibits an elongation at break of at least 50% at a temperature of −50° C.

Embodiment No. 34 is the melt-blend resin composition according to Embodiment No. 1, wherein the partially crystalline elastomer exhibits an elongation at break of at least 75% at a temperature of −50° C.

Embodiment No. 35 is the melt-blend resin composition according to Embodiment No. 1, wherein the partially crystalline elastomer exhibits an elongation at break of at least 100% at a temperature of −50° C.

Embodiment No. 36 is the melt-blend resin composition according to Embodiment No. 1, wherein the melt-blend resin composition consists essentially of: (a) from 60 parts to 99 parts per hundred weight resin in the blend of an amorphous cycloolefin polymer composition exhibiting a glass transition temperature in the range of from 30° C. to 200° C.; and (b) from 40 parts to 1 part per hundred weight resin in the blend of a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

Embodiment No. 37 is the melt-blend resin composition according to Embodiment No. 1, wherein the composition exhibits characteristic localized stress whitening only upon high speed impact testing in accordance with ASTM Test Method D 3763.

Embodiment No. 38 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 3.

Embodiment No. 39 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 2.

Embodiment No. 40 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 1.

Embodiment No. 41 is the melt-blend resin composition according to Embodiment No. 1, wherein the composition exhibits characteristic localized stress whitening only upon high speed impact testing in accordance with ASTM Test Method D 3763 and has a characteristic localized stress whitening index of less than 0.5.

Embodiment No. 42 is a melt-blend resin composition prepared by melt-blending: (a) from 60 parts to 99 parts per hundred weight resin in the blend of an amorphous cycloolefin polymer composition consisting essentially of one or more copolymers of ethylene and norbornene exhibiting a glass transition temperature in the range of from 30° C. to 200° C.; and (b) from 40 parts to 1 part per hundred weight resin in the blend of a partially crystalline, cycloolefin elastomer of norbornene and ethylene having at least one glass transition temperature (Tg) of less than 30° C., a crystalline melting temperature of less than 125° C. and a % crystallinity by weight of 40% or less.

Embodiment No. 43 is the melt-blend resin composition according to Embodiment No. 42, comprising an amorphous cycloolefin polymer of ethylene and norbornene having a weight average molecular weight of from 25,000 Daltons to 400,000 Daltons.

Embodiment No. 44 is the melt-blend resin composition according to Embodiment No. 42, comprising an amorphous cycloolefin polymer of ethylene and norbornene having a weight average molecular weight of from 50,000 Daltons to 250,000 Daltons.

Embodiment No. 45 is the melt-blend resin composition according to Embodiment No. 42, comprising an amorphous cycloolefin polymer of ethylene and norbornene having a weight average molecular weight of from 75,000 Daltons to 150,000 Daltons.

Embodiment No. 46 is a melt-blend resin composition prepared by melt-blending: (a) from 20 parts to 60 parts per hundred weight resin in the blend of a first amorphous cycloolefin polymer composition exhibiting a first glass transition temperature (Tg); (b) from 20 parts to 60 parts per hundred weight resin in the blend of a second amorphous cycloolefin polymer composition exhibiting a second glass transition temperature (Tg) which differs from the first glass transition temperature of the first amorphous cycloolefin copolymer composition; and (c) from 25 parts to 1 part per hundred weight resin in the blend of a partially crystalline, cycloolefin elastomer of norbornene and ethylene having at least one glass transition temperature (Tg) of less than 30° C., a crystalline melting temperature of less than 125° C. and a % crystallinity by weight of 40% or less.

Embodiment No. 47 is the melt-blend resin composition according to Embodiment No. 46, wherein the first glass transition temperature (Tg) of the first amorphous cycloolefin polymer composition is in the range of from 30° C. to 70° C. and the second glass transition temperature (Tg) of the second amorphous cycloolefin polymer composition is in the range of from 75° C. to 200° C.

Embodiment No. 48 is the melt-blend resin composition according to Embodiment No. 46, wherein the first glass transition temperature (Tg) of the first amorphous cycloolefin polymer composition is in the range of from 30° C. to 70° C. and the second glass transition temperature (Tg) of the second amorphous cycloolefin polymer composition is in the range of from 120° C. to 200° C.

Embodiment No. 49 is the melt-blend resin composition according to Embodiment No. 46, wherein the first glass transition temperature (Tg) of the first amorphous cycloolefin polymer composition is in the range of from 30° C. to 70° C. and the second glass transition temperature (Tg) of the second amorphous cycloolefin polymer composition is in the range of from 75° C. to 120° C.

Embodiment No. 50 is the melt-blend resin composition according to Embodiment No. 46, wherein the first glass transition temperature (Tg) of the first amorphous cycloolefin polymer composition is in the range of from 30° C. to 50° C. and the second glass transition temperature (Tg) of the second amorphous cycloolefin polymer composition is in the range of from 75° C. to 200° C.

Embodiment No. 51 is the melt-blend resin composition according to Embodiment No. 46, wherein the first glass transition temperature (Tg) of the first amorphous cycloolefin polymer composition is in the range of from 30° C. to 50° C. and the second glass transition temperature (Tg) of the second amorphous cycloolefin polymer composition is in the range of from 120° C. to 200° C.

Embodiment No. 52 is the melt-blend resin composition according to Embodiment No. 46, wherein the first glass transition temperature (Tg) of the first amorphous cycloolefin polymer composition is in the range of from 30° C. to 50° C. and the second glass transition temperature (Tg) of the second amorphous cycloolefin polymer composition is in the range of from 75° C. to 120° C.

Embodiment No. 53 is the melt-blend resin composition according to Embodiment No. 46, wherein the first glass transition temperature (Tg) of the first amorphous cycloolefin polymer composition is in the range of from 55° C. to 100° C. and the second glass transition temperature (Tg) of the second amorphous cycloolefin polymer composition is in the range of from 120° C. to 200° C.

Embodiment No. 54 is the melt-blend resin composition according to any one of Embodiment Nos. 46 to 53 wherein the melt-blend resin composition consists essentially of a ternary mixture of the first amorphous cycloolefin polymer composition and the second amorphous cycloolefin polymer composition and the partially crystalline, cycloolefin elastomer of norbornene and ethylene which has at least one glass transition temperature (Tg) in the range of from −10° C. to 15° C., a crystalline melting temperature in the range of from 60° C. to 125° C. and a % crystallinity by weight in the range of from 5% to 40%.

Embodiment No. 55 is the melt-blend resin composition according to any one of Embodiment Nos. 46 to 54, wherein the first amorphous cycloolefin polymer composition is miscible with the second amorphous cycloolefin polymer composition as characterized by a single glass transition temperature (Tg) intermediate of the glass transition of the first amorphous cycloolefin polymer composition and the second amorphous cycloolefin polymer composition.

Embodiment No. 56 is the melt-blend resin composition according to any one of Embodiment Nos. 46 to 54, wherein the first amorphous cycloolefin polymer composition consists essentially of a first copolymer of ethylene and norbornene and second amorphous cycloolefin polymer composition consists essentially of a second copolymer of ethylene and norbornene.

Embodiment No. 57 is a melt-blend resin composition prepared by melt-blending: (a) from 60 parts to 94.5 parts per hundred weight resin in the blend of an amorphous cycloolefin polymer composition exhibiting a glass transition temperature (Tg) in the range of from 30° C. to 200° C.; (b) from 30-5 parts by weight of a thermoplastic elastomer; and (c) from 10 parts to 0.5 parts per hundred weight resin in the blend of a partially crystalline, cycloolefin elastomer of norbornene and ethylene having a glass transition temperature (Tg) of less than 30° C., a crystalline melting temperature of less than 125° C. and a % crystallinity by weight of 40% or less.

Embodiment No. 58 is the melt-blend resin composition according to Embodiment No. 57, wherein the thermoplastic elastomer is selected from styrene/butadiene block copolymers (SBS), styrene/ethylene/butadiene block copolymers (SEBS), styrene/isoprene block copolymers (SIS) and styrene/ethylene/propylene block copolymers (SEPS).

Embodiment No. 59 is the melt-blend resin composition according to Embodiment No. 58, wherein the thermoplastic elastomer is a SEBS block copolymer.

Embodiment No. 60 is the melt-blend resin composition according to Embodiment No. 57, wherein the composition contains from 5 to 0.75 parts per hundred weight resin in the blend of the partially crystalline cycloolefin elastomer.

Embodiment No. 61 is the melt-blend resin composition according to Embodiment No. 57, wherein the composition contains from 3 to 1 parts per hundred weight resin in the blend of the partially crystalline cycloolefin elastomer.

There is further provided shaped articles of the following embodiments:

Embodiment No. 62 is a shaped article made with a partially crystalline, cycloolefin elastomer of norbornene and ethylene having at least one glass transition temperature (Tg) in the range of from −10° C. to 15° C. and a crystalline melting temperature in the range of from 60° C. to 125° C. and a % crystallinity by weight in the range of from 5% to 40%.

Embodiment No. 63 is a shaped article according to Embodiment No. 62, wherein the partially crystalline elastomer of norbornene and ethylene has at least one glass transition temperature in the range of from 0° to 10° C.

Embodiment No. 64 is a shaped article according to Embodiment No. 62, wherein the partially crystalline elastomer of norbornene and ethylene has a melting temperature in the range of from 70° to 100° C.

Embodiment No. 65 is a shaped article according to Embodiment No. 62, wherein the partially crystalline elastomer of norbornene and ethylene has a melting temperature in the range of from 80° to 90° C.

Embodiment No. 66 is a shaped article according to Embodiment No. 62, wherein the partially crystalline elastomer of norbornene and ethylene has a crystallinity by weight in the range of from 10% to 30%.

Embodiment No. 67 is a shaped article according to Embodiment No. 62, wherein the partially crystalline elastomer of norbornene and ethylene has a norbornene content in the range of from 3 mol % to 20 mol %.

Embodiment No. 68 is a shaped article according to Embodiment No. 62, wherein the partially crystalline elastomer of norbornene and ethylene has a norbornene content in the range of from 5 mol % to 15 mol %.

Embodiment No. 69 is a shaped article according to Embodiment No. 62, wherein the partially crystalline elastomer of norbornene and ethylene has a norbornene content in the range of from 7 mol % to 11 mol %.

Embodiment No. 70 is a shaped article according to Embodiment No. 62, wherein the partially crystalline elastomer of norbornene and ethylene has a weight average molecular weight in the range of from 25,000 to 500,000 Daltons.

Embodiment No. 71 is a shaped article according to Embodiment No. 62, wherein the partially crystalline elastomer of norbornene and ethylene has a weight average molecular weight in the range of from 50,000 to 450,000 Daltons.

Embodiment No. 72 is a shaped article according to Embodiment No. 62, wherein the partially crystalline elastomer of norbornene and ethylene has a weight average molecular weight in the range of from 75,000 to 300,000 Daltons.

Embodiment No. 73 is a shaped article according to Embodiment No. 62, wherein the partially crystalline elastomer of norbornene and ethylene has a weight average molecular weight in the range of from 100,000 to 200,000 Daltons.

Embodiment No. 74 is a shaped article according to Embodiment No. 62, wherein the partially crystalline elastomer of norbornene and ethylene exhibits a Melt Volume Rate @ 260° C. and 2.16 kg load of from 2 ml/10 min to 50 ml/10 min.

Embodiment No. 75 is a shaped article according to Embodiment No. 62, wherein the partially crystalline elastomer of norbornene and ethylene exhibits a Melt Volume Rate @ 260° C. and 2.16 kg load of from 4 ml/10 min to 35 ml/10 min.

Embodiment No. 76 is a shaped article according to Embodiment No. 62, wherein the partially crystalline elastomer of norbornene and ethylene exhibits a Melt Volume Rate @ 260° C. and 2.16 kg load of from 6 ml/10 min to 24 ml/10 min.

Embodiment No. 77 is a shaped article according to Embodiment No. 62, wherein the partially crystalline elastomer of norbornene and ethylene exhibits a Melt Volume Rate @ 260° C. and 2.16 kg load of from 8 ml/10 min to 16 ml/10 min.

Embodiment No. 78 is a shaped article according to Embodiment No. 62, wherein the tubing consists essentially of a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

Embodiment No. 79 is a shaped article prepared from a blend of: (a) an amorphous cycloolefin polymer composition consisting essentially of one or more copolymers of ethylene and norbornene exhibiting a glass transition temperature in the range of from 30° C. to 200° C.; and (b) a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

Embodiment No. 80 is a shaped article according to any of the foregoing embodiments, wherein the partially crystalline elastomer of norbornene and ethylene has At least one glass transition temperature in the range of from 0° to 10° C.

Embodiment No. 81 is a shaped article according to any of the foregoing embodiments, wherein the partially crystalline elastomer of norbornene and ethylene has a melting temperature in the range of from 70° to 100° C.

Embodiment No. 82 is a shaped article according to any of the foregoing embodiments, wherein the partially crystalline elastomer of norbornene and ethylene has a melting temperature in the range of from 80° to 90° C.

Embodiment No. 83 is a shaped article according to any of the foregoing embodiments, wherein the partially crystalline elastomer of norbornene and ethylene has a % crystallinity by weight in the range of from 10% to 30%.

Embodiment No. 84 is a shaped article according to any of the foregoing embodiments, wherein the partially crystalline elastomer of norbornene and ethylene has a norbornene content in the range of from 3 mol % to 20 mol %.

Embodiment No. 85 is a shaped article according to any of the foregoing embodiments, wherein the partially crystalline elastomer of norbornene and ethylene has a norbornene content in the range of from 5 mol % to 15 mol %.

Embodiment No. 86 is a shaped article according to any of the foregoing embodiments, wherein the partially crystalline elastomer of norbornene and ethylene has a norbornene content in the range of from 7 mol % to 11 mol %.

Embodiment No. 87 is a shaped article according to any of the foregoing embodiments, wherein the partially crystalline elastomer of norbornene and ethylene has a weight average molecular weight in the range of from 25,000 to 500,000 Daltons.

Embodiment No. 88 is a shaped article according to any of the foregoing embodiments, wherein the partially crystalline elastomer of norbornene and ethylene has a weight average molecular weight in the range of from 50,000 to 450,000 Daltons.

Embodiment No. 89 is a shaped article according to any of the foregoing embodiments, wherein the partially crystalline elastomer of norbornene and ethylene has a weight average molecular weight in the range of from 75,000 to 300,000 Daltons.

Embodiment No. 90 is a shaped article according to any of the foregoing embodiments, wherein the partially crystalline elastomer of norbornene and ethylene has a weight average molecular weight in the range of from 100,000 to 200,000 Daltons.

Embodiment No. 91 is a shaped article according to any of the foregoing embodiments, wherein the partially crystalline elastomer of norbornene and ethylene exhibits a Melt Volume Rate @ 260° C. and 2.16 kg load of from 2 ml/10 min to 50 ml/10 min.

Embodiment No. 92 is a shaped article according to any of the foregoing embodiments, wherein the partially crystalline elastomer of norbornene and ethylene exhibits a Melt Volume Rate @ 260° C. and 2.16 kg load of from 4 ml/10 min to 35 ml/10 min.

Embodiment No. 93 is a shaped article according to any of the foregoing embodiments, wherein the partially crystalline elastomer of norbornene and ethylene exhibits a Melt Volume Rate @ 260° C. and 2.16 kg load of from 6 ml/10 min to 24 ml/10 min.

Embodiment No. 94 is a shaped article according to any of the foregoing embodiments, wherein the partially crystalline elastomer of norbornene and ethylene exhibits a Melt Volume Rate @ 260° C. and 2.16 kg load of from 8 ml/10 min to 16 ml/10 min.

Embodiment No. 95 is a shaped article according to any of the foregoing embodiments, wherein the tubing consists essentially of a partially crystalline, cycloolefin elastomer of norbornene and ethylene having a glass transition temperature in the range of from −10° C. to 15° C. and a crystalline melting temperature in the range of from 60° C. to 125° C. and a % crystallinity by weight in the range of from 5% to 40%.

Embodiment No. 96 is a shaped article according to any of the foregoing embodiments prepared from a blend of:
(a) an amorphous cycloolefin polymer composition consisting essentially of one or more copolymers of ethylene and norbornene exhibiting at least one glass transition temperature in the range of from 30° C. to 200° C.; and
(b) a partially crystalline, cycloolefin elastomer of norbornene and ethylene having a glass transition temperature in the range of from −10° C. to 15° C. and a crystalline melting temperature in the range of from 60° C. to 125° C. and a % crystallinity by weight in the range of from 5% to 40%.

Embodiment No. 97 is a shaped article according to any of the foregoing embodiments, having a multi-layer construction.

Embodiment No. 98 is a shaped article according to any of the foregoing embodiments, having a multi-layer construction wherein at least one layer comprises amorphous cycloolefin containing polymer with a glass transition temperature above 30 degrees Celsius.

Embodiment No. 99 is a shaped article according to any of the foregoing embodiments, wherein the shaped article includes medical tubing.

Embodiment No. 100 is a shaped article according to any of the foregoing embodiments, wherein the shaped article is a contact lens mold or component thereof.

Embodiment No. 101 is a shaped article according to any of the foregoing embodiments, wherein the shaped article is a container such as a bottle, a squeeze bottle or a squeeze tube.

Embodiment No. 102 is a shaped article according to any of the foregoing embodiments, wherein the shaped article is an eyedropper or eyedropper component.

Embodiment No. 103 is a shaped article according to any of the foregoing embodiments, wherein the shaped article is an elastomeric closure, optionally a pierceable elastomeric closure.

Embodiment No. 104 is a shaped article according to any of the foregoing embodiments, wherein the shaped article is selected from shrink film and shrink tubing.

While the invention has been described in detail, modifications within the spirit and scope of the invention will be readily apparent to those of skill in the art. In view of the foregoing discussion, relevant knowledge in the art and references including co-pending applications discussed above in connection with the Background and Detailed Description, the disclosures of which are all incorporated herein by reference, further description is deemed unnecessary. In addition, it should be understood that aspects of the invention and portions of various embodiments may be combined or interchanged either in whole or in part. Furthermore, those of ordinary skill in the art will appreciate that the foregoing description is by way of example only, and is not intended to limit the invention.

What is claimed is:

1. Shaped articles made with a partially crystalline, cycloolefin elastomer of norbornene and ethylene having at least one glass transition temperature (Tg) of less than 30° C., a crystalline melting temperature of less than 125° C. and a % crystallinity by weight of 40% or less.

2. Shaped articles according to claim 1, wherein the shaped article consists essentially of a partially crystalline, cycloolefin elastomer of norbornene and ethylene having at least one glass transition temperature in the range of from −10° C. to 15° C. and a crystalline melting temperature in the range of from 60° C. to 125° C. and a % crystallinity by weight in the range of from 5% to 40%.

3. Shaped articles according to claim 1, having a multi-layer construction, wherein at least one layer comprises a partially crystalline, cycloolefin elastomer of norbornene and ethylene having at least one glass transition temperature (Tg) of less than 30° C., a crystalline melting temperature of less than 125° C. and a % crystallinity by weight of 40% or less.

4. Shaped articles according to claim 1, having a multi-layer construction, wherein at least one layer comprises a partially crystalline, cycloolefin elastomer of norbornene and ethylene having at least one glass transition temperature (Tg) of less than 30° C., a crystalline melting temperature of less than 125° C. and a % crystallinity by weight of 40% or less and at least one layer is formed substantially without a partially crystalline, cycloolefin elastomer of norbornene and ethylene having at least one glass transition temperature (Tg) of less than 30° C., a crystalline melting temperature of less than 125° C. and a % crystallinity by weight of 40% or less.

5. Shaped articles according to claim 1, having a multi-layer construction wherein at least one layer comprises amorphous cycloolefin containing polymer with a glass transition temperature above 30 degrees Celsius.

6. Shaped articles according to claim 1, having a multi-layer construction wherein at least one layer comprises amorphous cycloolefin containing polymer with a glass transition temperature above 30° C. melt blended with a partially crystalline, cycloolefin elastomer of norbornene and ethylene having at least one glass transition temperature (Tg) of less than 30° C., a crystalline melting temperature of less than 125° C. and a % crystallinity by weight of 40% or less

7. Shaped articles according to claim 1, comprising an amorphous cycloolefin containing polymer with a glass transition temperature above 30 degrees Celsius melt blended with a partially crystalline, cycloolefin elastomer of norbornene and ethylene having at least one glass transition temperature (Tg) of less than 30° C., a crystalline melting temperature of less than 125° C. and a % crystallinity by weight of 40% or less.

8. Shaped articles according to claim 1, wherein the partially crystalline elastomer of norbornene and ethylene has a weight average molecular weight in the range of from 25,000 to 500,000 Daltons.

9. Shaped articles according to claim 1, wherein the partially crystalline elastomer of norbornene and ethylene has a weight average molecular weight in the range of from 50,000 to 450,000 Daltons.

10. Shaped articles according to claim 1, wherein the partially crystalline elastomer of norbornene and ethylene has a weight average molecular weight in the range of from 75,000 to 300,000 Daltons.

11. Shaped articles according to claim 1, wherein the partially crystalline elastomer of norbornene and ethylene has a weight average molecular weight in the range of from 100,000 to 200,000 Daltons.

12. A shaped article selected from: a contact lens mold or component thereof; a bottle; an eyedropper or eyedropper component; an elastomeric closure; shrink film; or shrink tubing, wherein said shaped article is made with a partially crystalline, cycloolefin elastomer of norbornene and ethylene having at least one glass transition temperature (Tg) of less than 30° C., a crystalline melting temperature of less than 125° C. and a % crystallinity by weight of 40% or less.

13. A shaped article according to claim 12, wherein the shaped article is a contact lens mold or component thereof.

14. A shaped article according to claim 12, wherein the shaped article is a container such as a bottle, a squeeze bottle or a squeeze tube.

15. A shaped article according to claim 12, wherein the shaped article is an eyedropper or eyedropper component.

16. A shaped article according to claim 12, wherein the shaped article is an elastomeric closure, optionally a pierceable elastomeric closure.

17. A shaped article according to claim 12, wherein the shaped article is selected from shrink film and shrink tubing.
